(19) United States
(12) Patent Application Publication
(10) Pub. No.: US 2024/0140588 A1
(43) Pub. Date: May 2, 2024

(54) AIRCRAFT WING STRUCTURE

(71) Applicant: Airbus Operations Limited, Bristol (GB)

(72) Inventor: Henry Edwards, Bristol (GB)

(21) Appl. No.: 18/377,066

(22) Filed: Oct. 5, 2023

(30) Foreign Application Priority Data
Oct. 31, 2022 (GB) 2216083.2

(51) Int. Cl. B64C 3/18; B64C 3/26

(52) U.S. Cl. CPC B64C 3/185; B64C 3/26

(57) ABSTRACT

An aircraft wing structure includes first and second unitary shell structures formed from a fiber-reinforced composite material. Each shell structure includes a partial front spar, a partial rear spar and a wing skin. The partial front spars of each shell structure and the partial rear spars of each shell structure are arranged to overlap to form front and rear spars respectively. A wing box structure is lightweight, strong and durable, with a lower overall part count than has been conventionally achievable. Aircraft systems equipment may be attached to the shell structures prior to, or after, assembly into a wing box.

### TECHNICAL FIELD

The disclosure herein relates to an aircraft wing structure, such as a wing box, wing tip or winglet. The disclosure herein also concerns a wing comprising such a structure, an aircraft comprising such a structure, a component of such a structure and a method of manufacturing an aircraft wing structure.

### BACKGROUND

Aircraft wings commonly comprise a wing box structure (also known as a torsion box). The wing box typically includes front and rear spars that extend along the span of the wing box, and ribs that extend chord-wise between the front and rear spars. Upper and lower wing covers extend between the spars to form the upper and lower boundaries of the wing box. Leading and trailing edge structures may be attached to the wing box so as to extend forward and aft of the front and rear spars respectively. The leading edge and trailing edge structures may include flight control surfaces, such as slat, flaps and spoilers.

The various components of a wing box are joined by drilling holes through adjacent components and installing rivets or other fasteners in the holes. According to this conventional method, each wing includes many joined components, and each component must be joined to the others. Often, at least some of the joints must be formed manually, for example where the joints are formed at internal locations in the wing that are difficult to access using automated joining machines. In order to assemble a wing, each of the components must be fastened together in a predetermined sequence, taking account of the tolerance stack at each stage. This is a time-consuming process. Furthermore, the fasteners and the connection portions of the various components contribute to the total weight of the final wing.

### SUMMARY

The disclosure herein provides an aircraft wing structure comprising first and second unitary shell structures, each shell structure comprising a partial front spar, a partial rear spar and a wing skin; the partial front spars of each shell structure and the partial rear spars of each shell structure being arranged to overlap to form front and rear spars respectively.

Preferably, each shell structure is formed of a composite material. Unlike traditional metallic wings, composites combine multiple materials for greater strength, lower weight and better durability. Lighter wings mean savings in fuel, CO2 and operating costs.

Advantageously, the shell structures are bonded together. This reduces or even removes the need for rivets or other fasteners, which provides a significant saving in weight of the final wing and assembly time.

The shell structures may be bonded together via a plurality of discrete adhesive sections, which may be arranged in a herringbone pattern.

Advantageously, the partial front spar of the first shell structure and the partial front spar of the second shell structure are spaced from each other to form an equipment space. Additionally, or alternatively, the partial rear spar of the first shell structure and the partial rear spar of the second shell structure are spaced from each other to form an, or a further, equipment space.

Aircraft systems equipment, such as electrical, hydraulic or communication systems equipment, may be advantageously attached to at least one of the partial front or rear spars.

The first and second shell structures may each further comprise at least one further partial spar; with the, or each, further partial spar of each shell structure being arranged to overlap to form at least one further spar.

Preferably, at least one of the first and second shell structures further comprises at least one flange outwardly overhanging one of the partial front and rear spars. The first and second shell structures may each further comprise front and rear flanges arranged to outwardly overhang the front and rear spars.

An aircraft wing structure constructed according to the disclosure herein preferably further includes a wing leading edge or trailing edge attached to a flange. The leading edge or trailing edge may include at least one flight control surface. Some or all of the flanges may include leading edge or trailing edge structures.

An aircraft wing structure constructed according to the disclosure herein may take the form of a wing box, wing tip or winglet, for example.

The disclosure herein further provides an aircraft wing, or an aircraft, incorporating an aircraft wing structure constructed according to the first aspect of the disclosure herein.

Another aspect of the disclosure herein provides a unitary shell structure configured to be attachable to another shell structure to form an aircraft wing structure, the unitary shell structure comprising a partial front spar, a partial rear spar and a wing skin.

Preferably, the unitary shell structure includes at least one flange outwardly overhanging one of the partial front and rear spars. Front and rear flanges may be provided to outwardly overhang the partial front and rear spars respectively.

Advantageously, aircraft systems equipment is attached to at least one of the partial front or rear spars.

The disclosure herein further provides a method of forming an aircraft wing structure comprising first and second unitary shell structures, each shell structure comprising a partial front spar, a partial rear spar and a wing skin; the method comprising connecting the partial front spars of each shell structure and the partial rear spars of each shell structure so as to overlap to form front and rear spars respectively.

Preferably, the method further comprises the step of forming the first and second unitary shell structures. The shell structures may be formed from composite material by any process known to the skilled person.

Advantageously, the shell structures are connected by being bonded together. This may be effected by applying a plurality of discrete adhesive sections to one or both shell structures. The discrete adhesive sections may be arranged in a herringbone pattern.

The method may further comprise the step of attaching aircraft systems equipment to at least one of the shell structures. This step may be carried out before the partial front spars and partial rear spars of the shell structures are connected together.

Preferably, the step of forming the shell structures also includes the step of forming at least one flange outwardly overhanging one of the partial front and rear spars, and the method further comprises the step of attaching a wing leading edge or trailing edge to a flange.

### BRIEF DESCRIPTION OF THE DRAWINGS

The disclosure herein will now be described, by way of example, with reference to the accompanying drawings in which:

FIG. 1 is a plan view of an aircraft including a wing structure constructed according to the disclosure herein;

FIG. 2 is a sectional view of components of the wing structure of FIG. 1;

FIG. 3a is a sectional view of the components of FIG. 2 being brought together;

FIG. 3b shows the components of FIG. 3a being bonded together;

FIG. 4 is a sectional view of the components of an alternative embodiment of the disclosure herein;

FIG. 5 is a sectional view of a wing structure constructed to another alternative embodiment of the disclosure herein;

FIG. 6 is a sectional view of a wing structure constructed according to a further alternative embodiment of the disclosure herein; and

FIG. 7 is a flow chart of a method of constructing an aircraft wing structure according to the disclosure herein.

### DETAILED DESCRIPTION

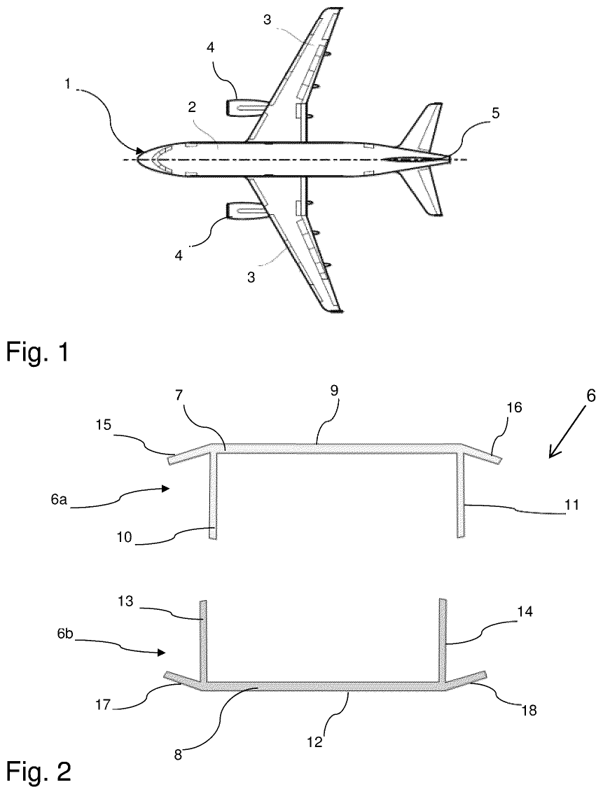

With reference to FIG. 1, an aircraft in the form of a typical transonic commercial passenger airplane is shown and indicated generally by the reference numeral 1. The aircraft 1 comprises a fuselage 2, wings 3, main engines 4 and a tail 5. It will be appreciated that the disclosure herein is applicable to a wide variety of aircraft types. For example, the aircraft may be for military purposes; may be for transporting passengers and/or cargo; may have jets, propellers or other propulsions systems; and may have any one of a variety of fuselage/wing configurations.

Each of the wings 3 comprises a wing box 6, otherwise known as a torsion box. The wing box 6 is the primary load-carrying structure of the wing; it forms the structural center of the wings and is also the attachment point for other wing components, such as a leading edge, a trailing edge and wing tip or winglet devices.

Components configured to form an aircraft wing structure in the form of a wing box 6 are shown in simplified form in FIG. 2, and a method of constructing the wing box is set out in the flow chart of FIG. 7. The sections of the flow chart indicated by broken lines are optional steps. The components comprise first and second shell structures, 7 and 8 respectively. Each shell structure 7, 8 is a unitary structure made from a composite material, such as carbon-fiber reinforced plastic (CFRP). One method of producing CFRP parts is by layering sheets of carbon fiber cloth into a mold. The alignment and weave of the cloth fibers is chosen to optimize the strength and stiffness properties of the resulting material. The mold is then filled with epoxy and is heated or air-cured. The carbon fiber cloth may have epoxy pre-impregnated into the fibers (a so-called pre-preg). The result is the production of laminated skin panels, which can be arranged to create a very strong, but lightweight structure. The method of constructing the wing box according to the disclosure herein may include the step of forming the shell structures (optional step 37 of FIG. 7) by any method known to the skilled person. Alternatively, the shell structures 7, 8 may be pre-made by a supplier and brought in for assembly.

The first shell structure 7 is arranged to form an upper portion 6a of the wing box and comprises an upper wing skin 9, a front partial spar 10 and a rear partial spar 11. The partial spars 10, 11 depend downwardly from the upper wing skin 9 and extend along the span of the wing box 6. The second shell structure 8 is arranged to form a lower portion 6b of the wing box and comprises a lower wing skin 12, a front partial spar 13 and a rear partial spar 14. The front and rear partial spars 13, 14 extend upwardly from the lower wing skin 12 along the span of the wing box 6.

Each shell structure 7, 8 includes flanges 15-18 extending outwardly from the front and rear of the respective wing skin portion. The first shell structure 7 has a frontward extending flange 15 and a rearward extending flange 16, both extending from the upper wing skin 9. The second shell structure 8 has a frontward extending flange 17 and a rearward extending flange 18, both extending from the lower wing skin 12. Each flange 15-18 extends along the length of the shell structure and forms a bracket for the mounting of equipment, such as leading and/or trailing edge components and/or moveable devices, such as flight control surfaces, as will be discussed later in this specification.

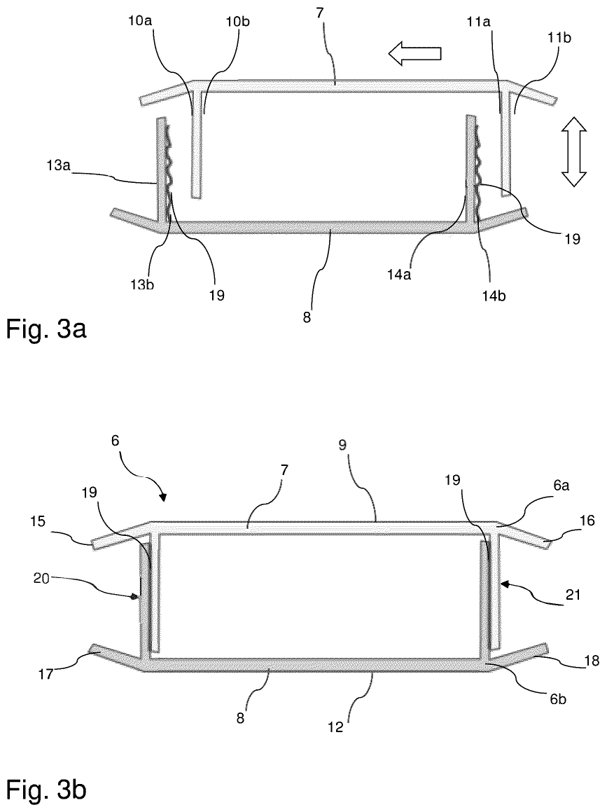

Each of the partial spars 10, 11, 13, 14 has frontward faces 10a, 11a, 13a and 14a respectively; and rearward faces 10b, 11b, 13b, 14b respectively, as shown in FIG. 3a. In order to make the wing box 6, adhesive 19 may be applied to at least some of the faces of the partial spars, and the shell structures are subsequently brought together, as indicated by arrows in FIG. 3a, so that the two front partial spars 10, 13 overlap to form a front spar 20 and the rear partial spars 11, 14 overlap to form a rear spar 21. The assembled wing box 6 and spars 20, 21 are shown in FIG. 3b. In FIG. 3a, adhesive is depicted as having been applied to the rearward faces 13b, 14b of the front partial spar and rear partial spar of the second (lower) shell structure 8. Of course, adhesive could be applied to the other faces 13a, 14a of the front and rear partial spars; to faces of the front and rear partial spars of the first (upper) shell structure (such as front faces 10a, 11a); or any combination thereof.

Adhesive may be applied by any suitable method known to the skilled person. In the drawings, the adhesive 19 is shown as a continuous layer; however, it may be advantageous to apply adhesive in discrete sections forming islands of adhesive. The discrete adhesive sections may take any suitable form; for example irregular blobs, square shapes forming a chequerboard pattern or rectangles arranged to form a regular pattern of L-shapes resembling a herringbone pattern. The discrete adhesive sections may help to provide improved structural support should a crack occur in one of the discrete adhesive sections. For example, the discrete sections may help to prevent cracks from propagating along the bond line. A herringbone pattern may help to provide improved load support and distribution by providing adjacent discrete adhesive sections which extend in different directions on the faces of the partial spars.

After application of the adhesive 19 (which is optional method step 38 of FIG. 7), the two shell structures 7, 8 are brought towards each other by relative movement so that faces of the front partial spars 10, 13 are brought into intimate contact, as are faces of the rear partial spars 11, 14. This bringing together of the shell structures 7, 8 so that the partial spars 10, 13 and 11, 14 overlap is method step 39 of FIG. 7. In FIG. 3a, the first (upper) shell structure 7 is shown being moved vertically with respect to the second shell structure 8, and then moved forward horizontally so that the frontward faces 10a, 11a of the front partial spar and rear partial spar of the first shell structure are brought up against the rearward faces 13b, 14b of the partial spars of the second shell structure that are coated with adhesive 19. Of course, this bringing together of the shell structures 7, 8 could be effected by bringing the second shell structure up towards the first shell structure; or by movement of both shell structures. The disclosure herein permits relative movement of the two shell structures up to the point of connecting the partial spars together. Relative vertical movement of the shell structures 7, 8 changes the amount of overlap of the partial spars; this allows engineering tolerances to be mitigated, so that a desired total wing thickness may be achieved in line with aerodynamic and internal fuel volume constraints. In effect, there is only one joining face to manage—with both partial spars of the first shell structure to one side of both partial spars of the second shell structure. This facilitates assembly of the wing box 6.

The final part of the assembly process (method step 40) comprises the joining of the shell structures 7, 8 to form the wing box 6. This part of the process typically involves setting or curing of the adhesive 19. The adhesive may be a cold curing adhesive, curable at room temperature. Alternatively, an adhesive could be employed that is cured by the application of heat or of UV light. The overlapping partial spars 10 and 13, and 11 and 14, may be clamped together during the curing process. Alternatively, temporary fasteners may be used to hold the overlapping partial spars together during curing. As an alternative to the application of adhesive to the shell structures, fasteners, such as rivets, could be employed to join the overlapping partial spars together. Alternatively, a combination of adhesive and fasteners could be used. Thermoplastic welding may also be employed, or any other suitable joining technique known to the skilled person.

As a further alternative, one or both of the shell structures 7, 8 may be formed in an uncured, or partially uncured, condition, and maintained in that state until the joining/curing step 40 of the method of assembly. At this stage the shell structure(s) 7, 8 would be completely co-cured with the adhesive. This would allow the full wing box 6 to be consolidated in one curing step.

The complete wing box structure 6 comprises an upper wing skin 9, lower wing skin 12, front spar 20 and rear spar 21, formed by a low number of components and one joining face. A wing box structure 6 constructed according to the disclosure herein is lightweight, strong and durable, with a lower overall part count than has been conventionally achievable. The wing box 6 is easy and quick to assemble, making it suitable for automated assembly.

In these drawings, the shell structures 7, 8 are depicted as having the same shape, with the lower shell structure 8 simply being the inverse of the upper shell structure 7. Such an arrangement would be easy to manufacture as only one set of molds would be required to form the shell structures. It is anticipated that the shell structures 7, 8 would likely have different respective overall shapes, particularly the wing skin parts 9, 12, in dependence on the desired aerodynamic profile of the completed wing.

As previously mentioned, the shell structures 7, 8 include flanges 15-18. In the assembled wing box 6, these form brackets for the mounting of secondary structures, such as fixed trailing edge panels, leading edge panels, flight control surfaces, or any combination thereof, by methods known to the skilled person. The subsequent mounting of secondary structures to the wing box 6 is optional step 41 of FIG. 7. The flanges 15-18 are formed as an integral part of the respective shell structure, with carbon fibers running continuously from the wing skins 9 and 12 outwardly into the flange parts 15, 16 and 17, 18 respectively.

Previously, such flanges were formed as part of the adjacent spar by, for example, making the spar C-shaped or I-shaped. The combined spar and flanges were then added to the wing box by a bolted joint extending through the flange of the spar and the wing skin. However, a fastener-filled hole under compression or tension causes reductions in the strain that can be absorbed by the wing skin. It has been proposed to overcome this problem by integrating a spar and wing skin together into a single component. However, a flange or bracket would then need to be bolted to that spar. In-tank access in the wing would be needed to facilitate installation, or at the very least a drilling operation to pre-install the flange before assembling the wing box. Furthermore, the gap between the flange and the wing skin would need to be filled to provide a tolerable aerodynamic surface. By providing shell structures 7, 8 having integral flanges 15-18, the disclosure herein provides brackets for the attachment of secondary wing structures without detrimentally affecting the strength of the completed wing box 6, and with no extra assembly steps required.

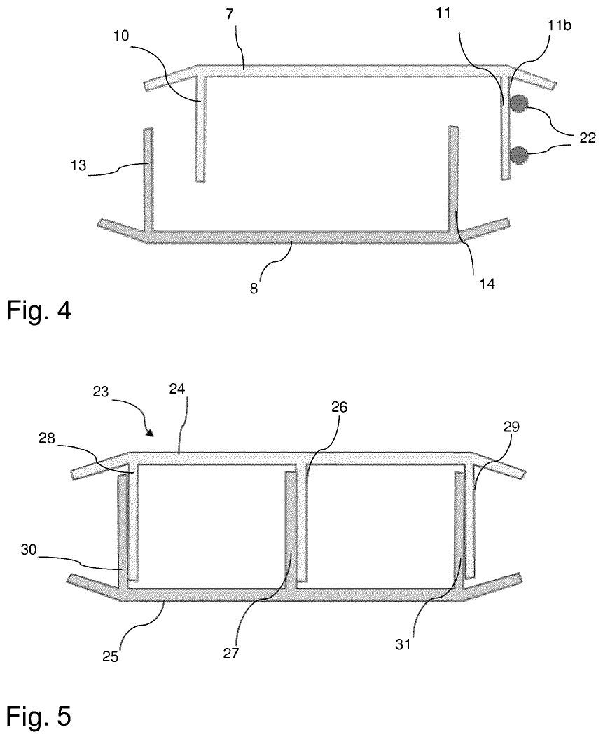

FIG. 4 shows the components of a wing box structure constructed according to an alternative embodiment of the disclosure herein. In this embodiment, the shell structures 7, 8, are substantially similar to those shown in FIGS. 2 and 3, but in this example one of the shell structures 7 has been pre-equipped with aircraft systems equipment 22 (optional method step 42 of FIG. 7) prior to the shell structures 7, 8 being assembled into a wing box. In this example, the equipment 22 is shown as having been attached to the rearward face 11b of the rear partial spar 11. Of course, either or both partial spars 10, 11, 13, 14 of either or both shell structures 7, 8 could be equipped prior to assembly. The equipment 22 could include electrical harnesses, electrical components, cables (e.g. fiber optic cables), hydraulic systems and pipework, fuel lines, or any combination thereof. Previously, it was not possible to pre-equip any part of a wing box with equipment because the structure would subsequently need to be drilled for assembly with fasteners, and the resulting swarf from drilling could cause contamination or damage to the equipment. In this embodiment, the assembly of the shell structures 7, 8 to form the wing box 6 would likely require a cold curing or UV-cured adhesive to be employed on the partial spars, as the application of heat may result in damage to the equipment. This embodiment of the disclosure herein may further reduce assembly time and may allow a reduction in inventory. This is because the systems equipment 22 may be installed at any convenient time and not merely when assembly of the wing box structure 6 is completely finished.

FIG. 5 illustrates an assembled wing box structure 23 constructed according to another embodiment of the disclosure herein. In this example, each of the shell structures 24, 25 has been formed with a further partial spar 26, 27 respectively, intermediate the front and rear partial spars 28-31. When the shell structures 24, 25 are brought together, the front partial spars 28, 30 overlap to form a front spar; the rear partial spars 29, 31 overlap to form a rear spar; and the intermediate partial spars 26, 27 overlap to form an intermediate spar. Adhesive may be applied to any or all of the partial spars 26-31 prior to assembling the wing box 23; alternatively (or additionally), fasteners or other joining techniques may be used to join the partial spars together. The provision of an intermediate spar 26, 27 improves the load-bearing capability of the completed wing. Of course, several intermediate spars may be formed by creating shell structures having a plurality of partial intermediate spar portions which are arranged to be joined together by adhesive (or fasteners) when the wing box structure is assembled. This embodiment of the disclosure herein has further strength benefits, to the extent that one or more ribs or other reinforcing components may be omitted from the wing.

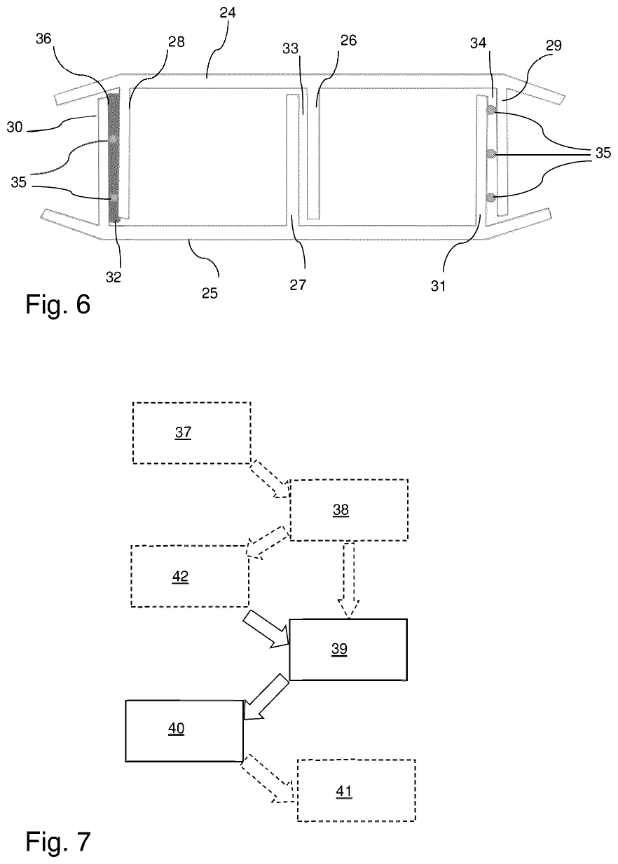

FIG. 6 shows a wing box structure constructed according to another embodiment of the disclosure herein. In this variant, the shell structure components 24, 25 are the same as those in FIG. 5, with each component comprising front (28, 30), rear (29, 31) and intermediate (26, 27) partial spars. In this embodiment, the shell structures 24, 25 are assembled so that the partial spars overlap but are slightly spaced from one another to form spars having internal cavities 32, 33 and 34. These cavities 32-34 are suitable spaces for the installation of aircraft systems equipment 35, such as wires, cables and/or sensors. The shell structures 24, 25 may be pre-equipped with aircraft systems equipment 35 prior to assembly into a wing box (as in optional method step 42). In this drawing, equipment 35 is shown in the cavities 32, 34 between the front partial spars 28, 30 and rear partial spars 29, 31 respectively. Of course, equipment 35 may be installed in the cavity 33 between the intermediate spar portions 26, 27. The front partial spars 28, 30 are shown as being bonded together by sufficient adhesive 36 to fill the cavity 32. Equipment 35 may be incorporated into the bonding adhesive 36 itself, or placed into the spaces between discrete adhesive sections. Adhesive is absent from the cavity 34 between the rear partial spars 29, 31. Instead, equipment 35 may be fastened to either or both rear partial spars 29, 31 prior to assembly, either directly by fasteners, or via wiring harnesses (not shown) or other mounting devices. The rear partial spars 29, 31 may then be joined by fasteners (not shown) arranged to space the partial spars from each other so as to form the cavity 34. Similarly, the intermediate partial spars 26, 27 may be joined so that there is a predetermined distance between them. As a further alternative, the shell structures 24, 25, may be designed so that, when assembled, there is a cavity between some of the partial spars and no cavity (i.e. intimate contact) between others of the partial spars. Installing equipment 35 in the cavities 32-34 between the partial spars may result in a neater organisation of systems equipment and a simplified interface for other equipment in the wing, as well as providing an opportunity to incorporate more aircraft systems equipment in the wing box.

Variations may be made without departing from the scope of the disclosure herein. For example, although the disclosure herein has been described with reference to the construction of the main wing box structure, the disclosure herein would be particularly suitable for constructing a wing tip structure, such as a folding wing tip, winglet or downlet. The disclosure herein could also be employed to form any or all of the parts of the empennage, such as the tail fin, the tail plane, elevators and/or rudder. Furthermore, the disclosure herein could be employed to form leading edge or trailing edge panels; or flight control surfaces, such as flaps, slats or spoilers. Further variations of the disclosure herein will be apparent to the person skilled in the art.

It should be understood that modifications, substitutions and alternatives may be apparent to one of ordinary skill in the art and can be made without departing from the scope of the disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft wing structure comprising first and second unitary shell structures, each shell structure comprising a partial front spar, a partial rear spar and a wing skin, the partial front spars of each shell structure and the partial rear spars of each shell structure overlapping to form front and rear spars respectively.

2. The aircraft wing structure of claim 1, wherein each shell structure is formed of a composite material.

3. The aircraft wing structure of claim 1, wherein the shell structures are bonded together.

4. The aircraft wing structure of claim 3, wherein the shell structures are bonded together via a plurality of discrete adhesive sections.

5. The aircraft wing structure of claim 4, wherein the discrete adhesive sections are arranged in a herringbone pattern.

6. The aircraft wing structure of claim 1, wherein the partial front spar of the first shell structure and the partial front spar of the second shell structure are spaced from each other to form an equipment space.

7. The aircraft wing structure of claim 1, wherein the partial rear spar of the first shell structure and the partial rear spar of the second shell structure are spaced from each other to form an, or a further, equipment space.

8. The aircraft wing structure of claim 1, comprising aircraft systems equipment attached to at least one of the partial front or rear spars.

9. The aircraft wing structure of claim 1, wherein the first and second shell structures each comprise at least one further partial spar, and the or each further partial spar of each shell structure are arranged to overlap to form at least one further spar.

10. The aircraft wing structure of claim 1, wherein at least one of the first and second shell structures comprises at least one flange outwardly overhanging one of the partial front and rear spars.

11. The aircraft wing structure of claim 1, wherein the first and second shell structures each comprise front and rear flanges outwardly overhanging the partial front and rear spars respectively.

12. The aircraft wing structure of claim 10, comprising a wing leading edge or trailing edge attached to a flange.

13. The aircraft wing structure of claim 12, wherein the leading edge or trailing edge includes at least one flight control surface.

14. The aircraft wing structure of claim 1, in a form of a wing box, wing tip or winglet.

15. An aircraft wing comprising an aircraft wing structure of claim 1.

16. An aircraft comprising the aircraft wing structure of claim 1.

17. A unitary shell structure configured to be attachable to another shell structure to form an aircraft wing structure, the unitary shell structure comprising a partial front spar, a partial rear spar and a wing skin.

18. The unitary shell structure of claim 17, comprising at least one flange outwardly overhanging one of the partial front and rear spars.

19. The unitary shell structure of claim 17, comprising front and rear flanges outwardly overhanging the partial front and rear spars respectively.

20. The unitary shell structure of claim 17, comprising aircraft systems equipment attached to at least one of the partial front or rear spars.

21. A method of forming an aircraft wing structure comprising first and second unitary shell structures, each shell structure comprising a partial front spar, a partial rear spar and a wing skin, the method comprising effecting relative movement of the first and second shell structures so that the partial front spars and the partial rear spars of the shell structures overlap to form front and rear spars respectively.

22. The method of claim 21, comprising forming the first and second unitary shell structures.

23. The method of claim 21, wherein the shell structures are formed from composite material.

24. The method of claim 21, wherein the shell structures are connected by being bonded together.

25. The method of claim 24, wherein the shell structures are bonded together via a plurality of discrete adhesive sections.

26. The method of claim 25, wherein the discrete adhesive sections are arranged in a herringbone pattern.

27. The method of claim 21, comprising attaching aircraft systems equipment to at least one of the shell structures.

28. The method of claim 27, wherein attaching equipment to the or each shell structure is carried out before effecting relative movement of the first and second shell structures so that the partial front spars and the partial rear spars of the shell structures overlap to form front and rear spars.

29. The method of claim 21, wherein at least one of the first and second shell structures comprises at least one flange outwardly overhanging one of the partial front and rear spars, and the method comprises attaching a wing leading edge or trailing edge to a flange.
